(19) United States
(12) Patent Application Publication
(10) Pub. No.: US 2008/0036192 A1
(43) Pub. Date: Feb. 14, 2008

(54) Combination book and box

(75) Inventor: Shari Kaufman, Westport, CT (US)

Correspondence Address: Alan B. Clement;Locke Lord Bissell & Liddell LLP, 885 Third Avenue, 26th Floor, New York, NY, 10022, US

(73) Assignee: Innovative USA, Inc.

(21) Appl. No.: 11/501,560

(22) Filed: Aug. 9, 2006

(51) Int. Cl. B42D 1/00

(52) U.S. Cl. 281/15.1

(57) ABSTRACT

A book having a storage means capable of storing manipulatives wherein the book is comprised of a book component and a storage component, the storage component being a box which can attach to a cover of the book and can be opened and closed independently of whether the book is opened or closed.

### FIELD OF THE INVENTION

The present invention relates to a book that is useful with manipulative pieces. Manipulative pieces typically are interactive game or learning pieces that are useful in working directly with the book. More particularly, the present invention is related to a book, which is provided with a storage space for storing the manipulative pieces. Most particularly, the present invention is related to a book having a box construction attached to a cover of the book that is sealable and unsealable to contain manipulatives useful in the enjoyment of the book or can also contain other elements or objects that work directly with the book or not with the book and may be directly, indirectly or not related to the book itself.

### BACKGROUND OF THE INVENTION

A variety of books are currently on the market, which are packaged with manipulative pieces or game pieces for use with the book. These types of books typically have a high degree of educational and/or entertainment value for children. For instance, a certain variety of books have manipulative pieces that may be placed on the page to complete a picture. In other books, a number of manipulative pieces need to be placed adjacent to each other in order to complete a picture.

The general concept of attaching the associated manipulatives to the books or other printed matter such as magazines and albums is well known. One method is to attach the manipulatives to the cover of the book with a pressure sensitive adhesive whereby the consumer can peel off the manipulative from the book. In U.S. Pat. Nos. 5,301,803 and 5,303,825, both Hansen et al., cassettes are attached to printed sheets.

However, in these types of embodiments there is always the risk that because of the attachment method the cover of the book may become permanently defaced. Further, when a larger number of manipulatives are attached, the likelihood of defacement or loss of components becomes even more acute.

In Grant, U.S. Pat. No. 5,584,387 there is disclosed a combination book and package case assembly wherein the package case for containing the manipulatives is attached to a spiral binding by means of a hinge strip onto which the package case may be attached. However, this type of embodiment is severely limited to manipulatives which are relatively flat, and the package case can become displaced from the book due to its manner of attachment.

In Nelson, U.S. Pat. No. 4,365,438, there is taught a combination toy and book wherein the toy can be stored in a well cut-out from the pages of the book. However, this causes interruptions on a page, as each page has a hole cut into it and may interfere with the graphics of the front cover of the book reducing the opportunity for commercial exploitation.

In Hunt, U.S. Pat. No. 5,961,149, there is disclosed a toy train and book assembly wherein a map is drawn into the inside covers of a book, and a child can move a manipulative toy train around the map. However, this invention fails to teach an actual book, as there are no pages contained within. The '149 patent names its invention a book merely because it can be “stored in a book case or the like.” Additionally, due to the numerous “pop-ups” that are required to complete the map, only a very small box can be attached to the “book.”In Kaufman, U.S. Pat. Nos. 6,079,748 and 6,247,729, there is taught a book with storage for manipulatives wherein the manipulatives are stored in a tube attached to a cover of the book. However, there are limitations as to the type of manipulatives that can be stored due to the limitations imposed by the shape and size of the tube.

In Polick, U.S. Pat. Nos. 6,779,814 and 6,905,140, there is disclosed a combination interactive book and lockable storage device wherein one side of the invention is a book and the other side of the invention is a lockable storage compartment. However, this invention is more complex than a manipulative storage box. Additionally, the storage space is limited to only a portion of the invention, as the other portion is required for use by the book.

Several design patents teach book boxes (Ward, U.S. Pat. No. D429,761; Abiteoul, U.S. Pat. No. D386,677; Levine et al., U.S. Pat. No. D385,781 each teach a book box). However, it is impossible to independently open the book without also opening the box.

Accordingly, it would represent an advancement in the art of attaching manipulatives to books if a means of attachment were provided which overcame all of the above-noted drawbacks of the prior art. Also it would represent an advancement in the state of the art if a book with an improved means for containing the manipulatives or other objects was provided which was especially suitable as a travel book. Further, the attachment of the manipulative storage as a box on the back of the book enables the storage compartment to store cards and other manipulatives having the same size as the book and enables the book to fit onto shelves and other existing merchandising fixtures, which is extremely important for marketing the books.

### SUMMARY OF THE INVENTION

It is therefore an object of the present invention to provide a book that can be employed with manipulative pieces.

It is another object of the present invention to provide a book having a storage means for storing the manipulative pieces to be used with the book.

It is a further object of the present invention to provide a book with a storage means that enhances the marketability of the book.

It is still another object of the present to provide a book which has a manipulatives storage means that provides easy access to remove and replace the manipulatives without defacing, or even opening, the book.

It is a still further object of the present invention to provide a book having a manipulatives storage means that will lay flat on a planar surface and which facilitates stacking of the books.

It is another further object of the present invention to provide a book with a manipulative storage means that can shelve spine out and can further provide advertising copy and/or title information on the spine, and/or a visually aesthetic spine.

It is another further object of the present invention to provide a book with a manipulative storage means that does not obstruct the front cover of the book allowing for maximum graphic and commercial opportunity.

Accordingly, these objects and others are achieved by the book of the present invention, which comprises a book component and a box storage component, where the box storage component is attached to a cover of the book. Preferably the object comprises at least one manipulative piece, but may also comprise a liquid, or other object, including food.

In preferred embodiments the manipulatives are suitable for use with or related to the theme of the book. It is also contemplated herein that the box be of rectangular construction and may be relatively transparent such that the manipulative(s) may be seen through the box.

### BRIEF DESCRIPTION OF THE DRAWINGS

FIG. 1 depicts a top view of the unassembled box prior to being attached to the book cover.

FIG. 2 depicts a top view of the combination book and box in an assembled, closed position.

FIG. 3 depicts a partial side view of the combination book and box in an assembled closed position.

FIG. 4 depicts a view of the manner in which the assembled box is attached to the assembled book.

### DETAILED DESCRIPTION OF THE PRESENT INVENTION

The following description of preferred embodiments is presented to illustrate the present invention and is not to be construed to limit the scope of the appended claims in any manner whatsoever.

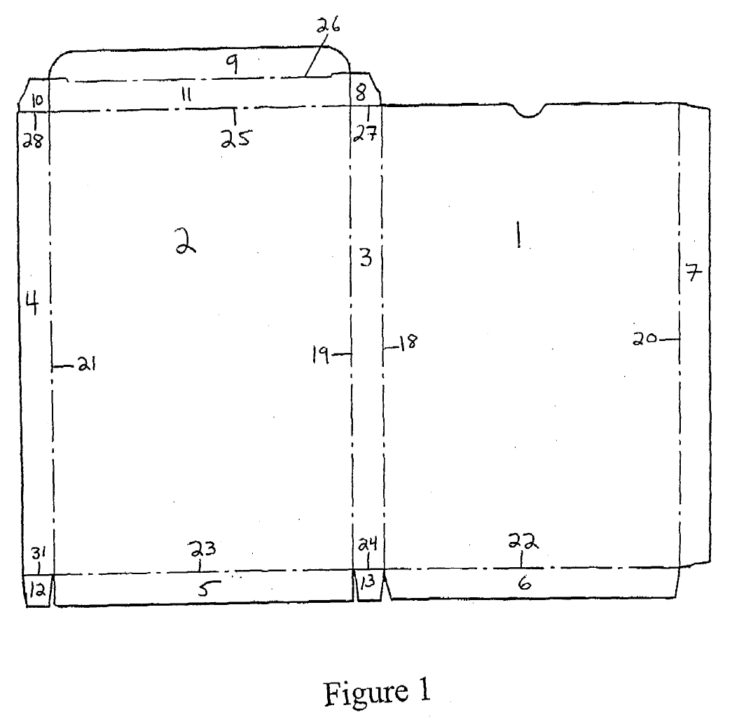

As best shown in FIG. 1, a box is formed in the normal manner. Solid lines are edges and dotted lines represent folds. There are two rectangular portions that form the front of the box (1) and the back of the box (2), which are substantially the same size as each other and as the book to which the box will be attached. The front of the box (1) and back of the box (2) are connected by a spine (3). When the box is folded together along the two spinal folds (18, 19), the two flaps (4) and (7) are folded along their respective folds (21, 20 respectively), and thus come into contact with each other to form an edge of the box (4, 7). The edge (4, 7) can be held together by any conventional means, for example, glue.

Once the box is folded along the two spinal folds (18, 19) and the two flaps (4) (7) have been attached together to form the edge of the box (4, 7), the bottom of the box is formed by folding the tabs (12, 13) along their respective folds (31, 24 respectively). The first bottom flap (5) is then folded along its fold (23), and the second bottom flap (6) is folded along its fold (22). The two bottom flaps (5, 6) are thus brought into contact with each other to form the bottom of the box (5, 6). The bottom (5, 6) can be held together by any conventional means, for example, glue.

The top of the box is the portion that can be opened and closed, independently of the status of the book. To close the box in order to ensure that the manipulatives stay inside, the tabs (8, 10) are folded along their respective folds (27, 28 respectively). The top flap (11) is then folded along its fold (25), and the closing flap (9) is folded along its fold (26). The closing tab (9) can be tucked underneath the front of the box (1) in order to secure it. Any other non-permanent means (not shown) can also be used to secure the closing tab (9) to the front of the box (1), for example, velcro, ties, zippers, springs, snaps, buttons, hooks, magnets, pressure sensitive adhesive, tab-and-slot mechanisms, etc.

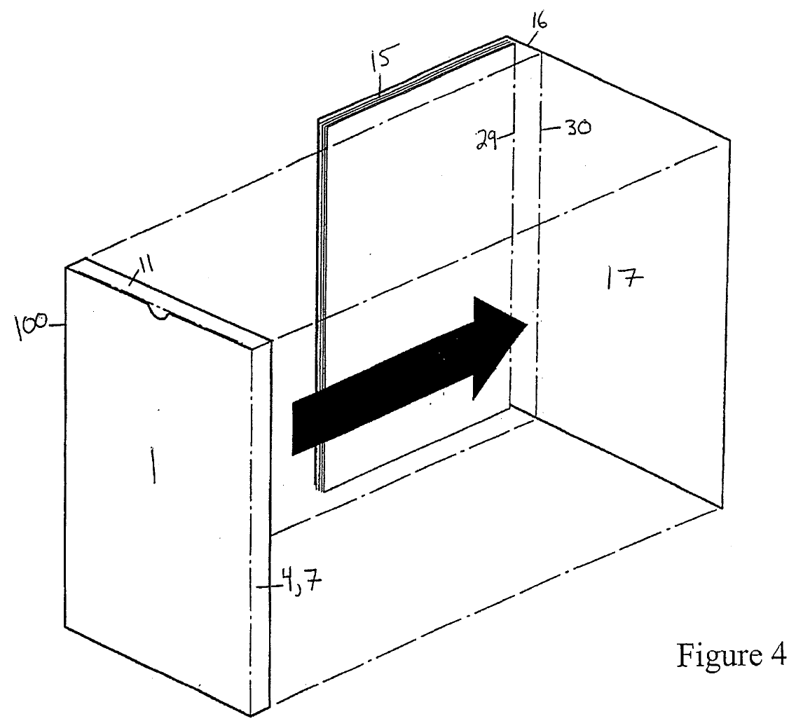

As best shown in FIG. 4, the now completed box (100) can be attached to the inside back cover (17) of the book. The pages (15) are attached to the spine (16) of the book. The book can close by folding the pages (15) along the fold (29) and folding the back cover (17) along the fold (30). In such a way is the combination book and box formed. See FIG. 3.

It is to be understood that other embodiments are also envisioned. For example, the box (100) can also be attached to the outside of the back cover. Additionally, the box can be attached to either the inside or the outside of the front cover, with pages (15) thus being attached to the back cover. There is no limit on the number of pages (15) that can be attached to the book, and it is also possible for a locking or closing mechanism to be placed on the book in order to keep it secured. However, regardless of whether or not the book is able to be secured, the box (100) will always have the ability to be independently opened or closed. It is also envisioned that the box (100) can be attached to one of the pages (15) in the book.

While it is preferred that the box be made of cardboard, it can also be formed of any other material capable of substantially retaining the dimensions and structure of the box over time, for example, plastic, wood, metal, etc. Depending on the type of material used to construct the box, it is envisioned that the box may be at least partially transparent, and may also be relatively transparent, so a user can see the manipulatives located within the box, if these are desired aspects. However, the box may also be opaque, in which case graphics optionally can be used to show the contents of the box, or the box may be left without graphics.

Additionally, while not necessary for the functioning of the combination book and box, it is also possible to attach a locking mechanism of any type known to lock closed either the book, the box, or both, with the caveat that the box must be able to be opened independently of the book, and vice-versa.

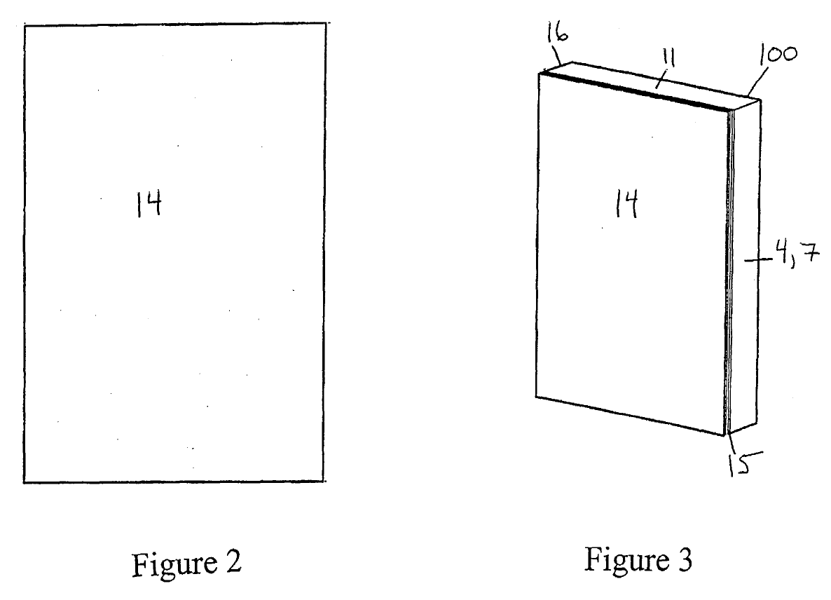

FIG. 2 shows a head-on view of the combination book and box in a closed position. All that is visible in this view is the front cover (14) of the book. FIG. 3 shows a slightly rotated picture of FIG. 2. In FIG. 3, the book is closed. The edge of the box (4, 7) is formed by attaching one flap (4) to another flap (7) and is visible as a single edge; the pages (15) are visible behind the front cover (14). Additionally, the top flap (11) is shown in a closed position, therefore the box is closed. Not shown is the closing tab (9) which is attached to the back cover (2), also not shown. The front cover (14) and pages (15) are attached to the spine of the book (16) and the box (10) is attached to the inside back cover (2, not shown) of the book.

It is envisioned that the manipulatives can be figures, puzzle pieces, flash cards, food, puppets, toys, building and/or construction blocks, crayons or other writing implements, bubbles, dolls, stuffed animals, trading cards, video games, CDs, DVDs, money or play money, small travel games, hair accessories, dice, make-up accessories, other small trinkets or any device or object that will add value to the product. It is also envisioned that various types of liquid material (e.g., disappearing ink) can be considered manipulatives, and the box would need to have a protective inner liner to protect against spills.

The above-mentioned patents are hereby incorporated by reference.

Having described the present invention, it will now be apparent that many changes and modifications may be made to the above-described embodiments without departing from the spirit and the scope of the present invention.

1. A book having a storage means capable of storing manipulatives, said book comprising:
a. a book component, and
b. a storage component comprising a box capable of storing said manipulatives
wherein said storage component is attached to said book component as a portion of a cover; said storage component is capable of being opened and closed independently of the book and wherein said book and storage component have substantially the same width and height as each other.

2. A book as defined in claim 1 wherein said box is attached at least in part to said back cover.

3. A book as defined in claim 1 wherein said box is attached at least in part to said front cover.

4. A book as defined in claim 1 wherein said box is attached at least in part to a page in said book.

5. A book as defined in claim 1 where manipulatives are stored in said storage component.

6. A book as defined in claim 5 wherein said manipulatives are related to the contents of said book.

7. A book as defined in claim 1 wherein said box is relatively transparent.

8. A book as defined in claim 1 wherein said box is partially transparent.

9. A book as defined in claim 1 wherein said box is not transparent.

10. A book as defined in claim 1 wherein said box has a locking mechanism.

11. A book as defined in claim 1 wherein said book has a locking mechanism.

12. A book as defined in claim 1 wherein said box is kept closed through use of one or more mechanisms selected from the group consisting of velcro, ties, zippers, springs, snaps, buttons, hooks, magnets, pressure sensitive adhesive, tab-and-slot mechanisms.

13. A book as defined in claim 1 wherein said box is attached to the inside of said front cover.

14. A book as defined in claim 1 wherein said box is attached to the inside of said back cover.

15. A book as defined in claim 1 wherein said box is opaque.

16. A book as defined in claim 1 wherein said box is formed from any material suitable for creating said storage component.

17. A book as defined in claim 5 wherein one or more of said manipulatives are related to the theme of said book.

18. A book as defined in claim 5 wherein one or more of said manipulatives are not related to the theme of said book.
